(19) United States
(12) Patent Application Publication
(10) Pub. No.: US 2024/0395530 A1
(43) Pub. Date: Nov. 28, 2024

(54) ION SOURCE ASSEMBLY

(71) Applicant: Micromass UK Limited, Wilmslow (GB)

(72) Inventor: Andrew Whatley, Manchester (GB)

(73) Assignee: Micromass UK Limited, Wilmslow (GB)

(21) Appl. No.: 18/693,796

(22) PCT Filed: Sep. 20, 2022
(86) PCT No.: PCT/GB2022/052365

§ 371 Date: Mar. 20, 2024

(30) Foreign Application Priority Data
Sep. 20, 2021 (GB) 2113374.9

(51) Int. Cl. H01J 49/16; H01J 49/04; H01J 49/14

(52) U.S. Cl. CPC H01J 49/164; H01J 49/0463; H01J 49/142

(57) ABSTRACT

An ion source assembly comprising: a target plate for holding a sample to be analysed; a laser for ionising the sample on the target plate so as to form analyte ions; one or more optical elements; an ion guide for guiding the analyte ions; a first gas port arranged to supply a first gas stream so as to urge material generated at the target plate away from the one or more optical element; and a second, different gas port arranged to supply a second gas stream that urges ions from the target plate, towards and into the ion guide.

### CROSS-REFERENCE TO RELATED APPLICATION

This application claims priority from and the benefit of United Kingdom patent application No. 2113374.9 filed on 20 Sep. 2021. The entire contents of this documents are incorporated herein by reference.

### FIELD OF THE INVENTION

The present invention relates generally to mass and/or mobility spectrometers. Embodiments described herein relate generally to ion sources for mass and/or mobility spectrometers, such as Matrix Assisted Laser Desorption Ionisation (“MALDI”) ion sources.

### BACKGROUND

Mass spectrometers comprising a Matrix Assisted Laser Desorption Ionisation (“MALDI”) ion source are known. MALDI techniques involve adding a suitable matrix material to an analytical sample, and then positioning the resulting sample on a target plate. A laser pulse is then directed onto the sample, causing analyte in the sample to be ablated and desorbed from the target plate. This generates a hot plume of gaseous molecules that contain both analyte ions and unwanted material, such as unwanted matrix material. The matrix that is used is chosen so as to have a strong absorption at the wavelength of the laser, and assists in the desorption and ionisation of the analyte.

The analyte ions are guided downstream by an ion guide, whereas the unwanted material may disperse and become deposited on various surfaces downstream of the target plate. For example, the unwanted material may be deposited on optical elements that are provided to direct the laser pulse onto the target plate. Such contamination is problematic and requires maintenance to remove it.

### SUMMARY

From a first aspect the present disclosure provides an ion source assembly comprising: a target plate for holding a sample to be analysed; a laser for ionising the sample on the target plate so as to form analyte ions; one or more optical elements;
an ion guide for guiding the analyte ions; a first gas port arranged to supply a first gas stream so as to urge material generated at the target plate away from the one or more optical element; and a second, different gas port arranged to supply a second gas stream that urges ions from the target plate, towards and into the ion guide.

The ion source assembly may comprise an enclosure housing the target plate, the ion guide and the one or more optical elements, wherein the first gas port is arranged to supply the first gas stream through a wall of the enclosure and the second gas port is arranged to supply the second gas stream through a wall of the enclosure.

The first gas port may be arranged in the wall of the enclosure adjacent to or proximate the one or more optical elements.

The second gas port may be arranged in the wall of the enclosure adjacent to or proximate the target plate.

The second gas port may supply gas to the region between the target plate and the ion guide.

The enclosure may be sealed gas-tight, apart from the first gas port, the second gas port and a further orifice for allowing ions transmitted by the ion guide to leave the enclosure. The enclosure may therefore only have three openings in it.

The one or more optical element may be any one, or any combination, of the following: a window for transmitting a laser beam from the laser to the target plate; a mirror for reflecting a laser beam from the laser; a camera; and a mirror for reflecting visible light, optionally to a camera.

The ion source assembly may comprise a first gas flow regulator configured to be adjustable so as to adjust the rate at which the first gas stream flows through the first gas port; and/or a second gas flow regulator configured to be adjustable so as to adjust the rate at which the second gas stream flows through the second gas port.

The ion source assembly may comprise a first pump for pumping the first gas stream into the first gas port; and/or a second pump for pumping the second gas stream into the second gas port.

The first pump may be configured to be controllable to vary the rate at which it pumps the first gas stream into the first gas port; and/or the second pump may be configured to be controllable to vary the rate at which it pumps the second gas stream into the second gas port.

The ion source assembly may be configured to maintain the pressure at the first and/or second gas port below atmospheric pressure.

The ion source assembly may be a MALDI ion source assembly.

The present disclosure also provides a mass and/or mobility spectrometer comprising the ion source assembly described herein.

The ion source assembly may comprise an enclosure housing the ion guide, wherein the enclosure includes an orifice for allowing ions to pass from the ion guide out of the enclosure, and wherein the spectrometer further comprises a vacuum chamber arranged adjacent the orifice to receive the ions.

The enclosure may further house the target plate and the one or more optical elements, and the first and second gas ports may be arranged through one or more wall of the enclosure.

The spectrometer may comprise a detector configured to detect a parameter related to the level of transmission of analyte ions by the ion guide through the orifice, wherein the spectrometer comprises control circuitry configured to automatically control the first and/or second gas flow based on the value of the detected parameter.

For example, the detector may detect the intensity of analyte ions, or of ions derived therefrom, and the spectrometer may then control the first and/or second gas flow based on the detected value of intensity.

The control circuitry may be configured to automatically vary the first and/or second gas flow rate until the value of the detected parameter indicates that the transmission of analyte ions has been increased, e.g. to at least a threshold or optimum value.

The present disclosure also provides a method of ionising an analytical sample comprising: providing an ion source assembly as described herein; providing an analytical sample on the target plate; illuminating the sample with a laser beam from the laser so as to form analyte ions and other material; supplying a first gas stream through the first gas port so as to urge said other material away from the one or more optical element; and supplying a second gas stream through the second gas port so as to urge the analyte ions from the target plate, towards and into the ion guide.

The method may comprise varying the rate at which the first gas stream flows through the first gas port; and/or varying the rate at which the second gas stream flows through the second gas port.

The varying of either one, or both, of the gas flows may be performed by controlling a gas flow regulator associated with one, or both, of the first and second gas ports. Alternatively, or additionally, this may be achieved by varying the operation of a pump that pumps gas into the first gas port and/or a pump that pumps gas into the second gas port.

The rate at which the first gas stream flows through the first gas port and the rate at which the second gas stream flows through the second gas port may be varied simultaneously.

The method may comprise maintaining the pressure at the first and/or second gas port below atmospheric pressure.

The present disclosure also provides a method of mass and/or mobility spectrometry comprising: a method of ionising an analytical sample as described herein; and mass and/or mobility analysing said analyte ions, or ions derived therefrom.

The present disclosure also provides an ion source assembly comprising: a target plate for holding a sample to be analysed; an ionisation device for ionising the sample on the target plate so as to form analyte ions; an ion guide for guiding the analyte ions; a first gas port arranged to supply a first gas stream so as to urge material generated at the target plate away from one or more surfaces to be protected from said material; and a second, different gas port arranged to supply a second gas stream that urges ions from the target plate, towards and into the ion guide.

### BRIEF DESCRIPTION OF THE DRAWINGS

Various embodiments of the present invention will now be described, by way of example only, and with reference to the accompanying drawings in which:

FIG. 1 shows a schematic of a spectrometer according to an embodiment of the present invention; and

FIG. 2 shows a schematic of an ion source assembly according to an embodiment of the present invention.

### DETAILED DESCRIPTION

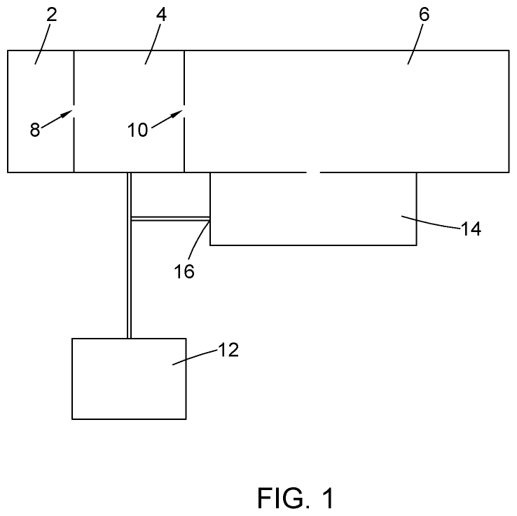

FIG. 1 shows a schematic of a spectrometer according to an embodiment of the present disclosure. The spectrometer comprises an ion source enclosure 2, a first vacuum chamber 4 and a second vacuum chamber 6. A first (inlet) orifice 8 is provided in the upstream wall of the first vacuum chamber 4 so as to allow ions to enter the first chamber 8 from the ion source enclosure 2. A mass analyser and/or mobility analyser and/or other device (not shown) may be arranged in the second vacuum chamber 6. An ion guide may be arranged in the first vacuum chamber 4 for guiding ions from the ion source enclosure 2 to pass through the first vacuum chamber 4 and into the second vacuum chamber 6.

A second orifice 10 is provided in the wall between the first and second vacuum chambers 4,6 so as to allow ions pass from the first vacuum chamber 4 into the second vacuum chamber 6. One or more device for manipulating and/or analysing ions is arranged in the second vacuum chamber 6. For example, an ion mobility separator and/or a mass analyser may be arranged in the second vacuum chamber 6 for analysing ions transmitted from the first vacuum chamber 4 into the second vacuum chamber 6 (or for analysing ions derived from those ions, e.g. their fragment or product ions). Additional devices may also be arranged in the second vacuum chamber 6, e.g. upstream of an ion mobility separator and/or mass analyser. For example, one or more of the following may be arranged in the second vacuum chamber 6: at least one ion guide; at least one ion trap, at least one fragmentation or reaction cell or device for fragmenting or reacting ions so as to form fragment or production ions; and a mass filter. An ion detector may also be provided in the second vacuum chamber, e.g. as part of the mass analyser.

A roughing pump 12 may be connected to the first vacuum chamber 4 for evacuating the first vacuum chamber 4. This pump reduces the pressure in the first vacuum chamber 4 to a pressure below atmospheric pressure. A pump such as a turbomolecular pump 14 may be connected to the second vacuum chamber 6 for evacuating the second vacuum chamber 6 to a pressure below that of the first vacuum chamber 4. It is typically desired to reduce the pressure in the second vacuum chamber 6 to a very low pressure in order for a mass analyser or other component housed therein to operate optimally. It will therefore be appreciated that the vacuum chambers are connected to pumps that pump gas out of them.

In use, an ion source in the ion source enclosure 2 ionises an analytical sample so as to produce ions. The ions then pass from the relatively high pressure ion source enclosure 2, through the first orifice 8, and into the lower pressure first vacuum chamber 4. The ions are then guided through the first vacuum chamber 4 by an ion guide and into the lower pressure second vacuum chamber 6, wherein they may be guided into a mass analyser.

Although only two vacuum chambers 4,6 downstream of the ion source enclosure 2 are shown and described above, it will be appreciated that one or more further vacuum chambers may be provided downstream of the ion source enclosure 2. For example, one or more further vacuum chamber may be arranged between the first and second vacuum chambers 4,6, with inter-chamber orifices in the walls between adjacent chambers so as to allow ions to pass through all of the vacuum chambers. These additional vacuum chambers may be at different pressures to the first and second vacuum chambers, such as at pressures intermediate those of the first and second vacuum chambers. These additional vacuum chambers may be pumped down by the second pump 14 or by one or more other vacuum pump.

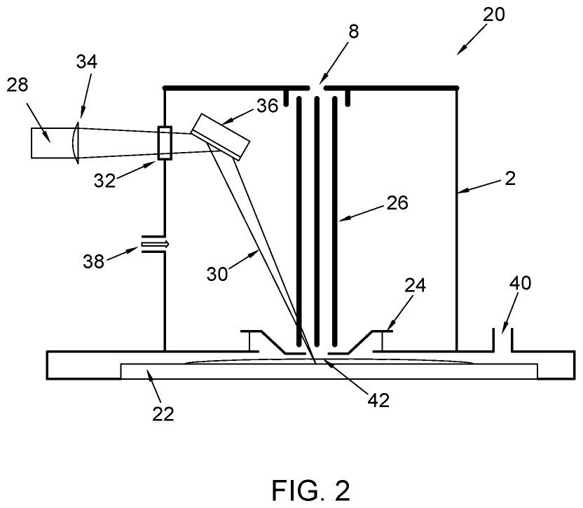

FIG. 2 illustrates a schematic of an ion source assembly 20 according to an embodiment of the present disclosure. The ion source assembly 20 comprises a MALDI ion source. The ion source assembly 20 comprises an ion source enclosure 2 that houses a MALDI target plate 22, an extraction electrode 24 and an ion guide 26. The extraction electrode 24 is configured to guide ions generated at the target plate 22 into the ion guide 26. The ion guide 26 is arranged to guide these ions to the first orifice 8 and into the first vacuum chamber 4.

A laser source 28 is provided for directing a laser beam 30 onto the target plate 22. The laser source 28 may be provided outside of the ion source enclosure 2, or less preferably may be provided inside of it. If the laser 28 is external to the enclosure 2 then a window 32 is provided in a wall of the enclosure 2 to allow a laser beam 30 from the laser source 28 to travel through the wall and to the target plate 22. A lens 34 may be provided for focusing the laser beam 30 to a focal point that is at the target plate 22. A mirror 36 may also be provided to reflect the laser beam 30 onto the target plate 22.

First and second gas ports 38,40 are also provided in the enclosure walls for supplying gas into the enclosure 2, as will be discussed further below. The ion source enclosure 2 may be sealed apart from the first and second gas ports 38,40 and the first orifice 8.

In use, a sample 42 is provided on the target plate 22. The laser source 28 is activated and causes a laser beam 30 to pass through the window 32 into the enclosure 2 and onto the sample 42 arranged on the target plate 22. The laser beam 30 may be focused by a lens 34 and/or reflected by a mirror 36 prior to striking the sample 42 on the target plate 22. The laser beam 30 is absorbed by the sample 42, causing it to generate a plume of gaseous material, which includes ionised analyte and also unwanted material, such as unwanted matrix material. The source is configured such that the analyte ions are guided into the ion guide 26 by the extraction electrode 24 and are then guided along the ion guide 26 so as to pass through the first orifice 8. In order to assist the analyte ions being guided by the ion guide 26, a collisional cooling gas is introduced into the enclosure 2 through the first gas port 38 in a wall of the enclosure 2. This gas flow is controlled so as to maintain the region of the enclosure 2 in which the ion guide 26 is located at a pressure sufficient to cause collisions between the analyte ions and the background gas molecules such that the ions are collisionally cooled and are hence able to be confined within the ion guide 26 by the voltages applied to the ion guide 26. In contrast, the unwanted material that is generated by the laser beam 30 striking the sample 42 on the target plate 22 is not guided by the ion guide 26 and instead disperses in the enclosure 2.

As described above, conventionally such unwanted material has undesirably deposited on various surfaces in the enclosure 2, such as on the window 32 that allows the laser beam 30 to enter the enclosure 2 or on other laser optics. This contamination may become baked onto the window 32 or other optics by the laser beam 30, which is clearly detrimental to the performance of the ion source and is required to be removed.

In order to inhibit or prevent such contamination, the first gas port 38 is located such that the gas flow therethrough reduces or prevents material generated at the target plate 22 from reaching the window 32 or other laser optics (such as a mirror 36 or lens 34, if located in the enclosure 2). For example, the first gas port 38 may be arranged so that the gas flow therethrough urges material away from the window 32 (or other laser optics). The ion source assembly 20 may comprise a camera, e.g. for viewing the target plate 22. In such embodiments the first gas port 38 may be arranged such that the gas flow reduces or prevents material generated at the target plate 22 from reaching the camera.

However, it has been recognised that although providing the collisional cooling gas flow in this manner both protects the optics from contamination and provides the relatively high pressure required to collisionally cool the ions such that they are efficiently confined in the ion guide 26, this gas flow arrangement and the relatively high pressure caused by it can inhibit the transmission of analyte ions from the target plate 22, into and through the ion guide 26.

In order to improve the transmission of analyte ions into and through the ion guide 26, embodiments of the present disclosure provide a second gas port 40 for providing a second gas flow into the enclosure 2. The second gas port 40 is arranged and configured such that gas flowing into the second gas port 40 passes along the surface of the target plate 22 to the location where the laser beam 30 is incident and into the entrance of the ion guide 26. As such, the gas flow from the second gas port 40 sweeps ions generated at the target plate 22 into the ion guide 26 and hence improves the transmission of these ions through the ion guide 26 and into the first orifice 8.

It has been recognised that increasing the gas flow from the first gas port 38 may enhance the protection of the optics from contamination, but may be detrimental to the transmission of ions through the ion guide 26. Also, increasing the gas flow from the second gas port 40 may enhance transmission of ions into and through the ion guide 26, but may urge unwanted contaminants towards the optics. Therefore the levels of first and second gas flows from the first and second gas ports 38,40, respectively, may be controlled so as to achieve an acceptable target level of transmission of ions through the ion guide 26 and/or an acceptable level of protection for the optics.

This may be achieved by providing gas flow regulators for adjusting the rate at which the gas streams flow through the first and/or second gas ports 38,40. Additionally, or alternatively, the one or more pump that pumps the gas into the first and/or second gas ports 38,40 may be controlled so as to vary the rate at which gas is pumped into the first and/or second gas ports 38,40.

It is contemplated that the variation and control of the gas flows may be automatically conducted by the spectrometer. For example, the spectrometer may comprise a detector configured to detect a parameter related to the level of transmission of analyte ions by the ion guide 26 and to automatically control the gas flow through the first and/or second gas ports 38,40 based on the detected parameter. For example, the detector may detect the intensity of analyte ions transmitted by the ion guide 26, or of ions derived therefrom (e.g. fragment of product ions of the analyte ions), and control the first and/or second gas flow based on the detected intensity. The spectrometer may comprise circuitry configured to automatically vary the first and/or second gas flow rate until the detected parameter indicates that the transmission of analyte ions has been increased, such as to at least a threshold or optimal value.

Although the present invention has been described with reference to preferred embodiments, it will be understood by those skilled in the art that various changes in form and detail may be made without departing from the scope of the invention as set forth in the accompanying claims.

For example, the ion guide 26 is illustrated as being a multipole ion guide, although it may alternatively be any type of ion guide, such as a ring stack ion guide.

Although embodiments have been described in which the ion source is a MALDI ion source, it will be appreciated that the invention is applicable to other types of ion source where contamination may occur.

Accordingly, the present disclosure also provides an ion source assembly comprising: a target plate for holding a sample to be analysed; an ionisation device for ionising the sample on the target plate so as to form analyte ions; an ion guide for guiding the analyte ions; a first gas port arranged to supply a first gas stream so as to urge material generated at the target plate away from one or more surfaces to be protected from said material; and a second, different gas port arranged to supply a second gas stream that urges ions from the target plate, towards and into the ion guide.

This ion source assembly may have any of the features described herein.

For example, the ionisation device may be a laser or other device such as an EI, DESI or REIMS device.

The one or more surface may be one or more optical element.

1. An ion source assembly comprising:
a target plate for holding a sample to be analysed;
a laser for ionising the sample on the target plate so as to form analyte ions;
one or more optical elements;
an ion guide for guiding the analyte ions;
a first gas port arranged to supply a first gas stream so as to urge material generated at the target plate away from the one or more optical element; and
a second, different gas port arranged to supply a second gas stream that urges ions from the target plate, towards and into the ion guide.

2. The ion source assembly of claim 1, comprising an enclosure housing the target plate, the ion guide and the one or more optical elements, wherein the first gas port is arranged to supply the first gas stream through a wall of the enclosure and the second gas port is arranged to supply the second gas stream through a wall of the enclosure.

3. The ion source assembly of claim 2, wherein the first gas port is arranged in the wall of the enclosure adjacent to or proximate the one or more optical elements.

4. The ion source assembly of claim 2 or 3, wherein the second gas port is arranged in the wall of the enclosure adjacent to or proximate the target plate.

5. The ion source assembly of claim 2, wherein the enclosure is sealed gas-tight, apart from the first gas port, the second gas port and a further orifice for allowing ions transmitted by the ion guide to leave the enclosure.

6. The ion source assembly of claim 1, wherein the one or more optical element is any one, or any combination, of the following: a window for transmitting a laser beam from the laser to the target plate; a mirror for reflecting a laser beam from the laser; a camera; and a mirror for reflecting visible light, optionally to a camera.

7. The ion source assembly of claim 1, comprising a first gas flow regulator configured to be adjustable so as to adjust the rate at which the first gas stream flows through the first gas port; and/or a second gas flow regulator configured to be adjustable so as to adjust the rate at which the second gas stream flows through the second gas port.

8. The ion source assembly of claim 1, comprising a first pump for pumping the first gas stream into the first gas port; and/or a second pump for pumping the second gas stream into the second gas port.

9. The ion source assembly of claim 8, wherein the first pump is configured to be controllable to vary the rate at which it pumps the first gas stream into the first gas port; and/or wherein the second pump is configured to be controllable to vary the rate at which it pumps the second gas stream into the second gas port.

10. The ion source assembly of claim 1, configured to maintain the pressure at the first and/or second gas port below atmospheric pressure.

11. The ion source assembly of claim 1, wherein the ion source assembly is a MALDI ion source assembly.

12. A mass and/or mobility spectrometer comprising the ion source assembly of claim 1.

13. The spectrometer of claim 12, wherein the ion source assembly comprises an enclosure housing the ion guide, wherein the enclosure includes an orifice for allowing ions to pass from the ion guide out of the enclosure, and wherein the spectrometer further comprises a vacuum chamber arranged adjacent the orifice to receive the ions.

14. The spectrometer of claim 13, comprising a detector configured to detect a parameter related to the level of transmission of analyte ions by the ion guide through the orifice, wherein the spectrometer comprises control circuitry configured to automatically control the first and/or second gas flow based on the value of the detected parameter.

15. The spectrometer of claim 14, wherein the control circuitry is configured to automatically vary the first and/or second gas flow rate until the value of the detected parameter indicates that the transmission of analyte ions has been increased, e.g. to at least a threshold or optimum value.

16. A method of ionising an analytical sample comprising:
providing an ion source assembly as claimed in claim 1;
providing an analytical sample on the target plate;
illuminating the sample with a laser beam from the laser so as to form analyte ions and other material;
supplying a first gas stream through the first gas port so as to urge said other material away from the one or more optical element; and
supplying a second gas stream through the second gas port so as to urge the analyte ions from the target plate, towards and into the ion guide.

17. The method of claim 16, comprising varying the rate at which the first gas stream flows through the first gas port; and/or varying the rate at which the second gas stream flows through the second gas port.

18. The method of claim 16, comprising maintaining the pressure at the first and/or second gas port below atmospheric pressure.

19. A method of mass and/or mobility spectrometry comprising:
a method of ionising an analytical sample as claimed in claim 18; and
mass and/or mobility analysing said analyte ions, or ions derived therefrom.

20. An ion source assembly comprising:
a target plate for holding a sample to be analysed;
an ionisation device for ionising the sample on the target plate so as to form analyte ions;
an ion guide for guiding the analyte ions;
a first gas port arranged to supply a first gas stream so as to urge material generated at the target plate away from one or more surfaces to be protected from said material; and
a second, different gas port arranged to supply a second gas stream that urges ions from the target plate, towards and into the ion guide.
